(19) United States
(12) Patent Application Publication
(10) Pub. No.: US 2006/0061132 A1
(43) Pub. Date: Mar. 23, 2006

(54) D.e.s. snow shield device

(76) Inventor: Dale E. Sua-an, Cherry Hill, NJ (US)

Correspondence Address: Dale E. Sua-an, 28 Greensward, Cherry Hill, NJ, 08002-4703, US

(21) Appl. No.: 10/946,589

(22) Filed: Sep. 22, 2004

(51) Int. Cl. B60J 11/00

(52) U.S. Cl. 296/136.01

(57) ABSTRACT

A portable device for shielding vehicles from snow during snow storm, consisting of several detachable members with legs and supports which, when assembled, form a roof-like structure resembling a modified cot. The device, spanning the whole length of the vehicle being shielded from the front to the rear, has snow-shielding materials that are either permanently attached to each detachable framed members, or simply superimposed and properly secured on top of the whole device. The superimposed shielding material is pulled either toward one side or toward the front or toward the rear of the vehicle to clear the device of its load of snow. The device being mountable on top of the vehicle before the start of the snow storm and then removed, cleared of its load of snow, and disassembled for storage in the trunk of the vehicle after the snow storm.

### CROSS-REFERENCE TO RELATED APPLICATIONS

Not Applicable

### STATEMENT REGARDING FEDERALLY SPONSORED RESEARCH OR DEVELOPMENT

Apparently there are no federally sponsored researches on this kind of invention. The Snow Shield Device may have some usefulness to individuals who would like their vehicles protected from snow during snow storm, but not to the Federal Government in general. It has no political usefulness whatsoever and does not need Government funding.

### INCORPORATION-BY-REFERENCE OF MATERIAL SUBMITTED ON THE COMPACT DISC, or REFERENCE TO A “MICROFICHE APPENDIX”.

Not Applicable

### BACKGROUND OF THE INVENTION

1. Field of Invention

The D.e.s. Snow Shield Device is a utility which is primarily and specifically intended to shield vehicles from snow whenever it snows. It addresses the need for something that minimizes the inconvenience encountered by people when clearing the top of their vehicles of snow after the snow storm. It is something functional and useful. Its unique features and specific use or purpose distinguish it from other related arts, like cots and canopies, and make it something new and unobvious. These make the idea patentable and the reasons this Application is submitted for Patent.

2. Description of Related Art

Cots and canopies, as an idea, are not new. They have been in existence for a long time. Cots are intended specifically for sleeping, not for shielding vehicles from snow. Canopies, like the “North American Canopy Enclosure”, are manufactured and used primarily “to protect cars and trucks from hot UV rays” and to “lower the temperature and to block out the sun or rain for great cook-outs”. And canopies are tents whose posts are normally planted or buried in the ground that they become immobile, steady, or semi-permanent structures that are not meant to be moved frequently from one place to another. They are so bulky that they cannot be easily stored in the vehicle's trunk and carried wherever one wants to go and park his vehicle. Currently, there are no cots nor canopies nor any known portable, adjustable, extendible, collapsible device that are specifically intended and used to shield the top of vehicles from snow, whenever it snows. If there are, they would be in the markets and widely in use, because they are a badly needed utility in Winter-time.

### BRIEF SUMMARY OF THE INVENTION

The D.e.s. Snow Shield Device, or D.e.s. S.S.D. in short, is a portable, adjustable, extendible, collapsible device intended specifically for shielding vehicles from snow, whenever it snows. It consists of several members with frames, legs, and supports. It can be designed either as one whole foldable piece, or it can be made up of several detachable members which, when assembled, form a roof-like structure resembling a modified cot or a modified canopy. The device has an appropriate, durable shielding material or cloth, which is either permanently attached to the frames of each separable members of the device, or it can be a separate, detachable piece simply super-imposed and properly secured on the whole length of the device which extends from the front to the rear of the vehicle. Superimposing the shielding material makes it easier to remove its load of snow by simply pulling it down either toward the side or toward the rear or toward the front of the vehicle, and emptying it of snow. The shielding materials are appropriate, durable and strong enough to withstand harsh elements. The device is mounted on top of the vehicle to be shielded before the snow storm starts and is secured with appropriate means, such as ropes or stretch cords, to keep it from being blown off by strong wind. It may be provided with detachable valance to protect the sides of the vehicle from snow. The device is so designed that it is easy to assemble, easy to mount on top of the vehicle, easy to remove and to empty of its load of snow, and easy to disassemble and to store in the trunk of the vehicle.

### OBJECTS AND ADVANTAGES

Accordingly, several objects and advantages of this invention are:

1. The device will keep the top of vehicle clean even during snow storm.

2. It will save the commuter so much time, energy, and the inconvenience of scraping snow from the top of the vehicle after the snow storm.

3. The device is portable, extendable, adjustable and collapsible.

4. It can easily be managed by any normal person.

5. It is simple and affordable.

6. It minimizes exposure to cold, because the device is easy to assemble, easy to mount on top of the vehicle, easy to remove and clear of its load of snow, easy to disassemble and to store inside the trunk of the vehicle. Further objects and advantages of the invention will become apparent from the consideration of the drawings and ensuing descriptions.

### BRIEF DESCRIPTION OF THE SEVERAL VIEWS OF THE DRAWINGS

FIG. 1=is the side view of the device mounted on top of a Sports Utility Vehicle. Fewer members of the device may be needed and used on top of the SUVs, because of their design.

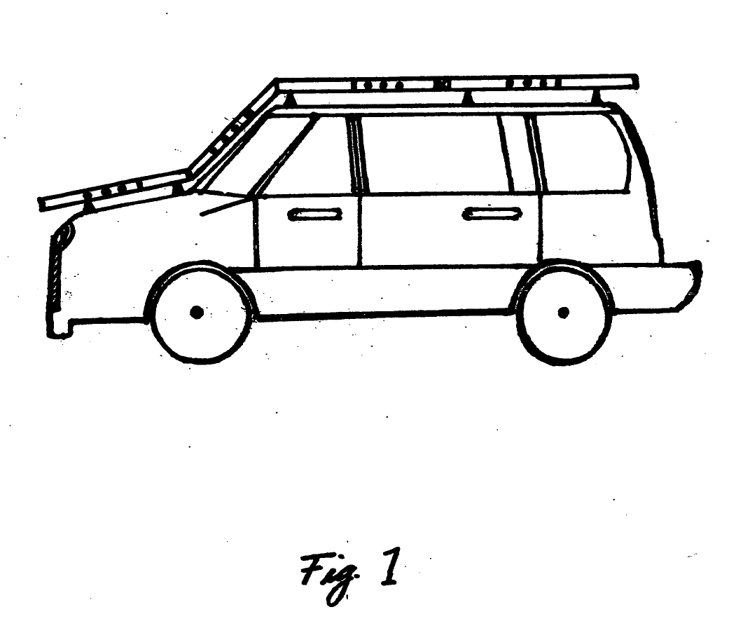

FIG. 2=shows the side view of the device mounted on top of a regular automobile. Most automobiles have more or less similar design on the top-side that they require all the members of the device.

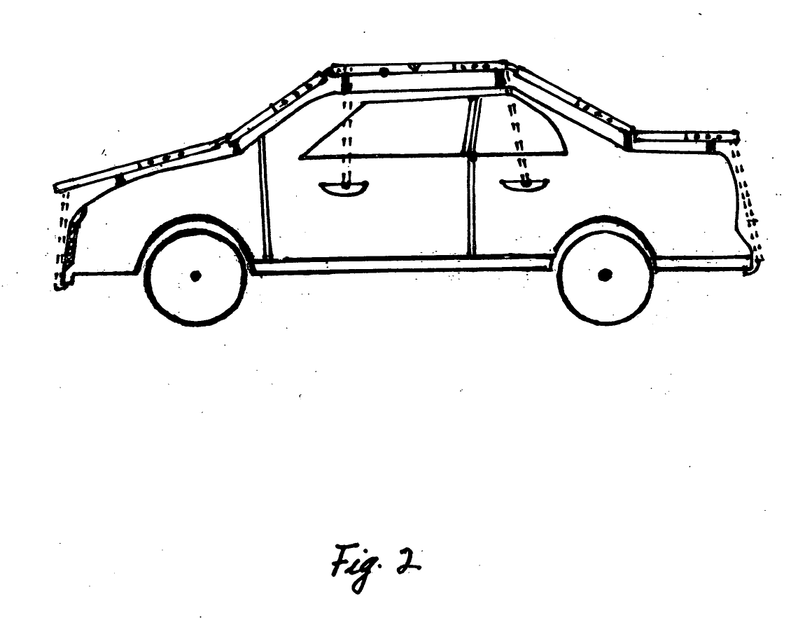

FIG. 3=Perspective view of the device with its 5 members and corresponding details.

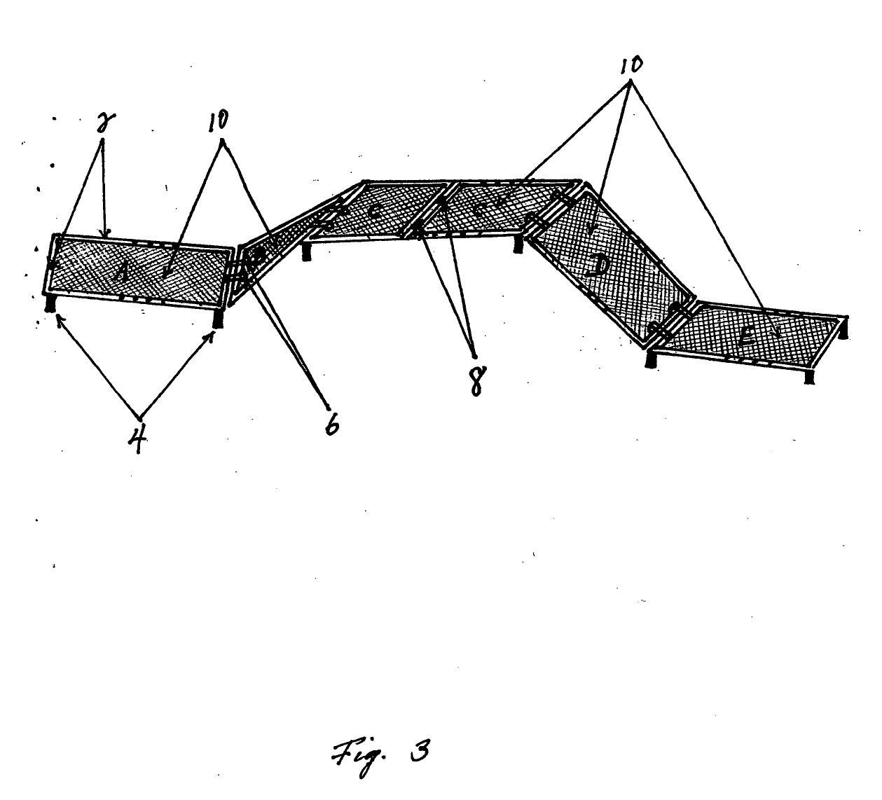

### DETAILED DESCRIPTION OF THE INVENTION

A-E=5 detachable, framed members of the D.e.s. Snow Shield Device, which extends from the front to the rear of the vehicle.

2=Frames of the members of the device. These hold the shielding materials.

4=Pairs of legs on both sides of each framed member of the device to prop each member and keep the device from sticking to the body of the vehicle.

6=Support gadgets or means for joining and holding the members of the device together.

8=Pair of hinges that join the frames of the folding member on top of the roof of the vehicle being shielded.

10=Shielding materials that are either permanently attached to each framed member of the device, or simply super-imposed on top of the device which spans the whole length and width of the vehicle. Where the shielding materials are permanently attached to the framed members of the device, each framed member is detached individually and emptied of its load of snow. The super-imposed shielding material is simply pulled down either toward the side, or toward the rear or toward the front of the vehicle, to clear it of snow.

12=Adjustment holes in the sides of each framed member of the device to either extend or shorten the members of the device in order to fit the device to the size of the vehicle being shielded.

### Alternative Embodiment

Although the D.e.s. Snow Shield Device has been described in this Specification to include specific components, it can actually exist and be designed with other variations or configurations. While my preceding descriptions contain many specificities, these should not be construed as limitations on the scope of this invention but rather as an exemplification of one preferred embodiment thereof. Many other variations or configurations are possible. The invention can come in varied makes, forms, shapes, designs and capacities. As long as they serve the same purpose of shielding vehicles from snow, they fall within the scope and claims of this idea.

Accordingly, the scope of this invention should be determined not only by the embodiments illustrated or examples given, but also by the appended claims and their legal equivalents.

I claim:

1) A device for shielding vehicles from snow.
1.a) Said device having several members which, when assembled, form a roof-like structure, resembling either a modified cot or a modified canopy.
1.a.1) Each member of said device having frames for holding the shielding materials, pairs of legs for propping each framed member, and means for joining and holding the framed members together.
1.b) said device having appropriate shielding materials for preventing snow from falling on and accumulating directly on the hood, roof and trunk of the vehicle being shielded:
1.b.1) Said shielding materials being either permanently attached to each framed member of said device, or simply super-imposed on top of the device, spanning the whole length of the vehicle being shielded.
1.c) Said device being mountable on top of a vehicle and made secure in place with appropriate means.
1.d) Said device having valance for shielding the sides of the vehicle from snow.
Whereby, the top of the vehicle being shielded by said device is kept free of snow and, thus, saving the commuter so much time, effort and the inconvenience of scraping snow from the top of the vehicle after the snow storm.
